(19) United States
(12) Patent Application Publication
(10) Pub. No.: US 2015/0190892 A1
(43) Pub. Date: Jul. 9, 2015

(54) METHOD FOR PRODUCING A HOUSING, ESPECIALLY A VALVE HOUSING

(71) Applicant: Robert Bosch GmbH, Stuttgart (DE)

(72) Inventor: Lutz Wondraczek, Korntal-Muenchingen (DE)

(21) Appl. No.: 14/411,338

(22) PCT Filed: Apr. 29, 2013
(86) PCT No.: PCT/EP2013/058855

§ 371 Date: Dec. 24, 2014

(30) Foreign Application Priority Data
Jun. 27, 2012 (DE) 10 2012 210 956.0

(51) Int. Cl. B23P 15/00

(52) U.S. Cl. CPC B23P 15/001

(57) ABSTRACT

A method for producing a housing is provided. In a first method step, connecting a material plate, having a main extension plane in each case, of the first, second and third material, respectively, in the first and second connection regions, the first and second connection region extending parallel to the main extension planes of the material plates in each case; in a second connection step, processing the interconnected material plates in order to produce the first, second and third zones of the housing.

### FIELD OF THE INVENTION

The present invention relates to a method for producing the housing, especially a valve housing for an electromagnetically actuable valve.

### BACKGROUND INFORMATION

Known from the related art, such as from the printed publication European Patent No. 169 9578 B1, for example, are valve housings, especially for fuel injectors, which have a classic three-part structure of an internal metallic flow guidance component and simultaneously housing part, this housing being formed by an intake nipple constituting an internal pole, a nonmagnetic intermediate part, and a valve seat support which accommodates a valve seat. In this case, the housing is known to have a hollow cylindrical metal housing, which has two magnetizable housing parts and an interposed amagnetic housing zone that magnetically separates the housing parts.

It is a challenge in the related art to manage a magnetic separation in a way that realizes high effective selectivity between magnetic areas and non-magnetic or amagnetic regions.

### SUMMARY

In contrast to the related art, the method of the present invention has the advantage that an improved magnetic separation is able to be realized in the magnetic circuit. This makes it possible to avoid magnetic short-circuit currents or at least reduce them, and to improve the efficiency factor of the magnetic circuit. For example, this may result in a considerable increase in the efficiency factor in solenoid valves and/or electric motors or generators. The magnetic separation is to be carried out in such a way that a magnetically conductive material (magnetically soft steel, e.g., ferritic or martensitic steel) is used in the region of the desired magnetic flux, and a magnetically non-conductive material (nonmagnetic material such as austenitic steel) is used in the region where no magnetic flux is desired.

In particular the high effective selectivity between magnetic and nonmagnetic regions and the low magnetizability or non-magnetizability (i.e., with a magnetic polarization J that runs toward zero or which vanishes, which is equivalent to a vanishing or, at most, very low magnetic susceptibility) of the austenitic region plays a decisive role in the effectiveness of the magnetic separation. According to the present invention, a plated material composite of ferritic steel is used for the cover layers and austenitic steel is used for the core layer, as semifinished product for corresponding components, especially as part of a housing. The components are to be removed from the semifinished product according to the desired position of the magnetic separation. The method of the present invention has the advantage that permanent adhesion of the different materials to each other is ensured because of the plating process or the plate process, and that very high effective selectivity, especially an effective selectivity in the range of less than 100 μm, is able to be achieved at the same time. The effective separation or the connection zone or connection region between the different materials in particular corresponds to the diffusion zone between the plating partners. The size of the separating layer is selectable in the present invention, especially through the appropriate selection of the plating partners.

According to one preferred further refinement of the present invention, during the second method step, the first, second and third zones are processed in a first subsection along an outer circumference, parallel to the axial direction, and in a second subsection along an inner circumference, parallel to the axial direction, the first substep being performed prior to the second substep, or the second substep being performed prior to the first substep. This advantageously makes it possible to realize the most different variants for the ultimate manufacture of the component or the housing for a fuel injector in the present invention.

According to the present invention, it is furthermore preferred that a stamping step takes place during the second method step, in particular a super-fine stamping step, for processing the inner circumference and/or for processing the outer circumference of the first, second and third zones. In this way, at least one surface of the component or the housing of the present invention is thereby able to be realized with the aid of a cost-effective stamping process or a super-fine stamping process in the present invention.

According to the present invention, it is furthermore preferred that a milling or drilling step takes place during the second method step, especially in order to process the inner circumference and/or to process the outer circumference of the first, second and third zones.

According to the present invention, this allows a production of the component or the housing of the present invention that is especially accurate in its dimensions and robust with regard to production tolerances.

According to one further specific embodiment of the present invention, it is preferred in the present invention that a water jet cutting step be implemented during the second method step, especially for processing the inner circumference and/or for processing the outer circumference of the first, second and third zones. This also allows an especially dimensionally accurate yet cost-effective realization of the component or the housing according to the present invention.

Exemplary embodiments of the present invention are illustrated in the drawing and explained in greater detail in the following description.

### BRIEF DESCRIPTION OF THE DRAWINGS

FIG. 1 show, schematically, a schematic sectional view of a housing of an electromagnetically actuable valve according to the present invention.

FIG. 2 shows, schematically, a sectional view of a fuel injector according to the related art.

FIG. 3 shows, schematically, a perspective view of a semifinished product made up of three material plates for the production of a housing according to the method of the present invention.

FIGS. 4 and 5 show schematic processing variants for producing a component from the semifinished product in order to manufacture a housing according to the present invention.

### DETAILED DESCRIPTION

In the various figures, identical parts have always been provided with the same reference symbols and are therefore usually labeled or mentioned only once as a rule.

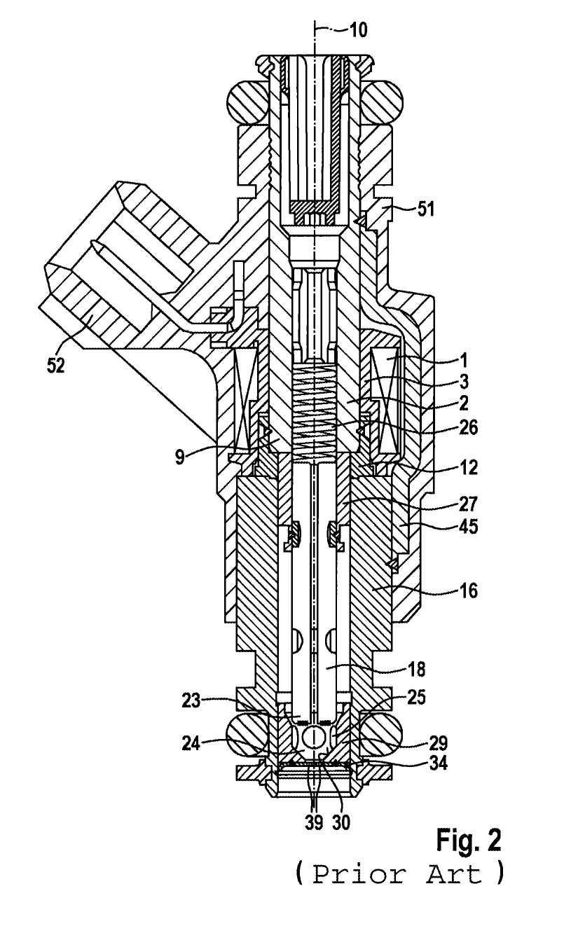

The electromagnetically operable valve in the form of a fuel injector known from the related art, which is shown in FIG. 2 by way of example and intended for fuel-injection systems of mixture-compressing, externally ignited or self-igniting internal combustion engines, has a tubular core 2, which is surrounded by a solenoid coil 1 and serves as fuel intake neck as well as an inner pole, core 2, for example, having a constant outer diameter over its entire length.

A coil shell 3 stepped in the radial direction accommodates a winding of solenoid coil 1 and, in conjunction with core 2, makes it possible for the fuel injector to have a compact design in the region of solenoid coil 1. A tubular, metallic nonmagnetic intermediate part 12 is sealingly connected by welding to a lower core end 9 of core 2, concentrically to a longitudinal valve axis 10, and partially surrounds core end 9 in an axial direction. A tubular valve-seat support 16, which is rigidly connected to intermediate part 12, extends downstream from coil shell 3 and intermediate part 12. An axially movable valve needle 18 is situated in valve seat support 16. A ball-shaped valve closure member 24, at whose circumference five flattened regions 25, for example, are provided for the fuel to flow past, is provided at downstream end 23 of valve needle 18. The fuel injector is actuated electromagnetically in a known manner. The electromagnetic circuit having magnetic coil 1, core 2, and an armature 27 is used for axially moving valve needle 18, and therefore, for opening the fuel injector against the spring force of a restoring spring 26, and for closing the fuel injector. Tubular armature 27 is fixedly connected to an end of valve needle 18 facing away from valve-closure member 24, such as by a welded seam, for example, and aligned with core 2. A cylindrical valve-seat member 29 having a fixed valve seat 30 is sealingly mounted by welding in the downstream end of valve-seat support 16 facing away from core 2. Spherical valve-closure member 24 of valve needle 18 interacts with valve seat 30 of valve-seat member 29, the valve seat tapering frustoconically in the direction of flow. At its lower end face, valve seat member 29 is rigidly and sealingly connected to a pot-shaped spray orifice disk 34, for instance by a welded seam, which is produced with the aid of a laser, for instance. At least one, e.g., four, spray-discharge orifice(s) 39 is/are provided in spray orifice disk 34, which is/are formed by eroding or stamping, for example. In order to conduct the magnetic flux to armature 27 for the optimal actuation of armature 27 when solenoid coil 1 is energized, and with that, for the secure and accurate opening and closing of the valve, solenoid coil 1 is surrounded by at least one conductive element 45, which, for instance, is developed as a bracket and used as a ferromagnetic element that surrounds solenoid coil 1 at least partially in the circumferential direction and lies against core 2 with its one end and against valve seat support 16 with its other end, and is able to be connected to them by welding, soldering or bonding, for instance. Core 2, nonmagnetic intermediate part 12 and valve seat support 16, which are firmly connected to one another and altogether extend over the entire length of the fuel injector, form an inner metallic valve pipe as skeleton and, with that, the housing of the fuel injector, as well. All additional functional groups of the valve are disposed within or around the valve pipe. This setup of the valve pipe involves the classical three-part design of a housing for an electromagnetically operable aggregate, such as a valve, having two ferromagnetic or magnetizable housing regions, which are magnetically separated from each other by a nonmetallic intermediate part 12, or which are at least connected to each other via a magnetic throttling point, for the effective conduction of the magnetic circuit lines in the region of armature 27. The fuel injector is largely surrounded by a plastic extrusion coat 51, which extends in the axial direction from core 2, across magnetic coil 1 and the at least one conductive element 45, to valve-seat support 16, the at least one conductive element 45 being completely covered in the axial and circumferential directions. A likewise extruded electrical connection plug 52, for instance, is also part of this plastic extrusion coat 51.

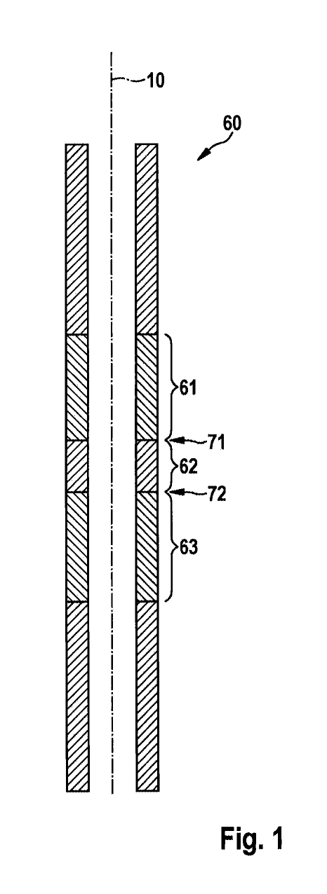

Using the method steps, schematically indicated in FIGS. 1 and 3 to 5, of the method according to the present invention for producing a fixed housing, it is advantageously possible to produce, in an especially simple and cost-effective manner, thin-walled housings 60 for the most varied purposes, such as preferably for electromagnetically operable valves, which are able to replace a three-part valve pipe described above. FIG. 1 shows a housing 60 according to the present invention in a heavily schematized sectional view (and especially without elements such as a solenoid coil, an armature, etc.). It is clear that housing 60 has a longitudinal extension along longitudinal valve axis 10, i.e., along an axial direction 10 (and at least in subregions is developed in rotationally symmetrical form about axial direction 10), housing 60 having at least one first zone 61 having a first material, a second zone 62 having a second material, and a third zone 63 having a third material. Along axial direction 10, first zone 61 is directly connected to second zone 62 in a first connection region 71. Also along axial direction 10, second zone 62 is directly connected to third zone 63 in a second connection region 72. To realize the aforementioned conductance of the magnetic flux, the second material has magnetic properties that differ from those of the first and third material.

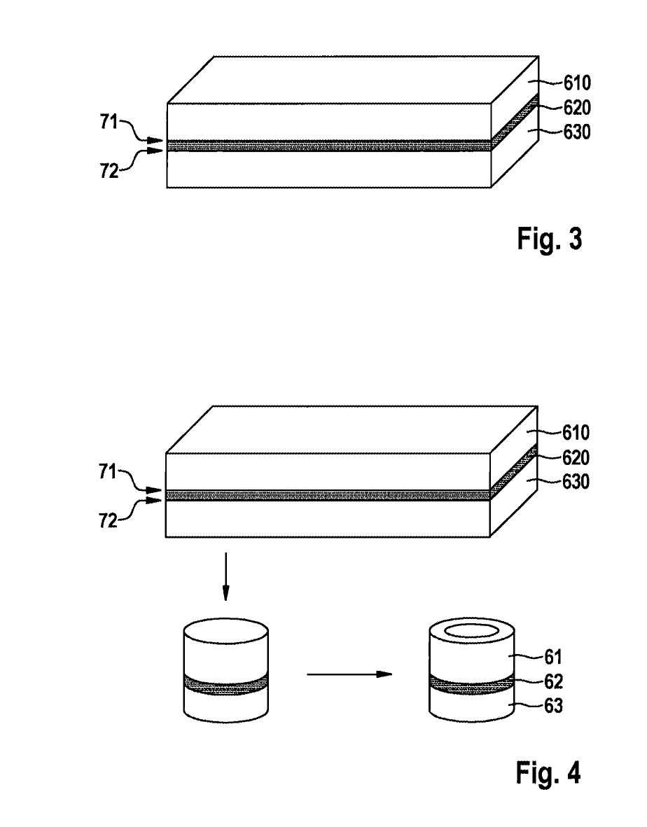

As shown in FIG. 3, a roll-bonded or explosive-cladded semifinished material having three material layers is produced in a first method step according to the present invention. In the process, a first material plate 610, a second material plate 620, and a third material plate 630 are joined to one another such that material plates 610, 620, 630, in each case, are situated on top of each other, i.e., first connection region 71 lies between first and second material plate 610, 620, parallel to the main extension planes of first and second material plates 610, 620, and second connection region 72 extends also parallel to the main extension planes of second material plate 620 and third material plate 630. By plating first material plate 610 by second material plate 620, and second material plate 620 by third material plate 630, an inseparable connection is achieved with the aid of temperature and pressure. Known techniques for joining material plates include roll-bonding, explosive cladding or roll weld cladding.

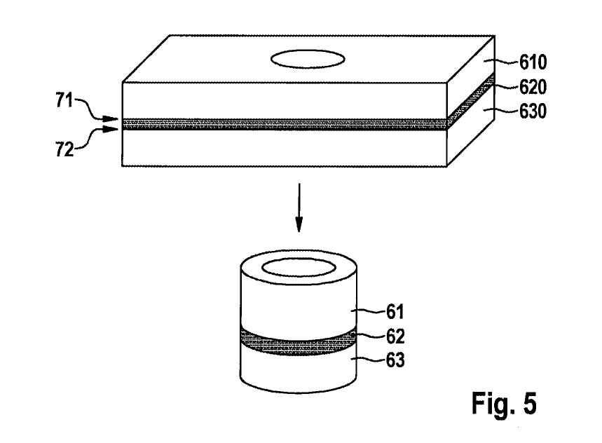

FIGS. 4 and 5 schematically illustrate machining variants for producing a component from the semifinished material for the purpose of manufacturing a housing 60 according to the present invention. According to FIG. 4, first a so-called blank is produced from the semifinished material (shown on top in FIG. 4), especially by laser-cutting and/or water jet cutting and/or stamping and/or milling from the plated semifinished product. In a second substep of the second method step, a sleeve component is produced from the blank, e.g., by stamping and/or drilling. The sleeve component, which is obtained following the second substep of the second method step, may then be connected as part of housing 60 to further housing components in order, for example, to realize a fuel injector, especially with the aid of a welding joint at the edge, facing away from the third zone, of first zone 61, and at the edge, facing away from first zone 61, of third zone 63. In the present invention, such a welding joint is advantageously situated in a region of housing 60 that has identical or similar magnetic properties in terms of the component regions to be connected, so that the welding operation has no adverse effect on the magnetic separation.

FIG. 5 illustrates a further machining variant for producing a component from the semifinished material in order to manufacture a housing 60 according to the present invention. In the machining variant shown in FIG. 5, first the inner diameter of the sleeve component to be produced is realized from the semifinished material, e.g., by laser cutting and/or water jet cutting and/or milling and/or stamping and/or drilling. In a second substep of the second method step, the outer diameter of the sleeve component is then produced by laser cutting and/or water-jet cutting and/or milling and/or stamping, so that the sleeve component for installation in a housing 60 according to the present invention is likewise obtained from the semifinished material in the second method step.

1.-7. (canceled)

8. A method for manufacturing a housing, the housing extending longitudinally along an axial direction and being rotationally symmetrical about an axial direction at least in subregions, the housing including at least one first zone having a first material, a second zone having a second material, and a third zone having a third material, and along the axial direction, the first zone being directly connected to the second zone in a first connection region, and along the axial direction, the second zone being directly connected to the third zone in a second connection region, the second material having different magnetic properties than the first and third material, the method comprising:
in each case connecting one material plate, having a main extension plane, of the first, second, and third material in the first and the second connection regions, the first and the second connection regions extending parallel to the main extension planes of the material plates in each case; and
processing the interconnected material plates in order to produce the first, second, and third zones of the housing.

9. The method as recited in claim 8, wherein the housing is a valve housing for an electromagnetically actuable valve.

10. The method as recited in claim 8, wherein the connection of the material plates in the connecting step is carried out one of by roll bonding and by explosive cladding.

11. The method as recited in claim 8, wherein during the processing step, the first, second, and third zones in each case is processed along an outer circumference parallel to the axial direction in a first substep, and along an inner circumference parallel to the axial direction in a second sub-step, the first sub-step being performed prior to the second sub-step, or the second sub-step being performed prior to the first sub-step.

12. The method as recited in claim 11, wherein during the processing step, a stamping step takes place, in order to at least one of process the inner circumference and to process the outer circumference of the first, second, and third zones.

13. The method as recited in claim 12, wherein the stamping is a high-precision stamping step.

14. The method as recited in claim 8, wherein during the processing step, one of a milling step and a drilling step takes place, in order to at least one of process the inner circumference and process the outer circumference of the first, second, and third zones.

15. The method as recited in claim 8, wherein during the processing step, a water-jet cutting step takes place to process at least one of the inner circumference and the outer circumference of the first, second, and third zones.

16. The method as recited in claim 8, wherein:
the second material is austenitic,
the first material is one of ferromagnetic and ferritic or martensitic, and the third material is one of ferromagnetic and ferritic.
